(19) United States
(12) Patent Application Publication
(10) Pub. No.: US 2020/0158047 A1
(43) Pub. Date: May 21, 2020

(54) Modular Engine

(71) Applicant: Lance Smith, Inc. dba Vermont Sports Car, Milton, VT (US)

(72) Inventors: Lance Smith, Milton, VT (US); Dan Farley, Milton, VT (US); Trygve Karlsen, Mjondalen (NO)

(21) Appl. No.: 16/611,254

(22) PCT Filed: Mar. 20, 2019
(86) PCT No.: PCT/US2019/023088

§ 371 Date: Nov. 6, 2019

Related U.S. Application Data
(60) Provisional application No. 62/645,482, filed on Mar. 20, 2018.

(51) Int. Cl. F02F 7/00; F01L 1/053; F02F 1/38

(52) U.S. Cl. CPC F02F 7/006; F01L 1/053; F02F 2007/0063; F01L 2103/00; F02F 1/38; F01L 2001/0537

(57) ABSTRACT

A modular engine is provided in which cylinder heads and camshaft carriers with different attributes can be interchanged with one another that allows for an engine head assembly to be put together for achieving various desired characteristics without the need to replace the entire engine or redesign a new engine.

### FIELD OF THE INVENTION

The present invention generally relates to internal combustion engines. In particular, the present invention is directed to a Modular Engine.

### BACKGROUND

Horizontally opposed engines are also commonly referred to as flat engines or boxer engines, which have a layout of opposing cylinders arranged in two banks on either side of a single crankshaft. While these engines are fairly common today in commercially available vehicles, there has also been interest in using this engine design for high performance race cars. However, the design of this type of engine poses significant challenges when increased compression/output is desired to meet the demands of racing teams.

In general, a horizontal or boxer type internal combustion engine has a cylinder head base, which contains cylinders, attached to a cylinder block. Water-cooled engines contain passages in the engine block where cooling fluid circulates. In air-cooled engines, the engine block has members extending away from the engine block. Pistons slide continuously within the cylinders and seal one end of the cylinder from the high pressure of the compressed air and combustion products. Cylinder heads are attached to the engine block by studs or bolts. The cylinder heads seal cylinders on the side opposite to the pistons and include intake ports, which include intake valves, and exhaust ports, which include exhaust valves. The cylinder head houses spark plugs and either a direct injection fuel delivery system or a port fuel delivery system. In addition, the cylinder head has an intake manifold that attaches to an intake port and an exhaust manifold that attaches to an exhaust port. A head gasket prevents gases from leaking between the engine block and the cylinder head. A camshaft carrier includes camshafts that control the opening, and closing of valves. A crankcase includes a sump that collects oil during operation of the engine so that it may be reused.

In addition, various types of valvetrains, lubrication circuits, scavenge circuits, and oil spray circuits may be used in an engine depending on the desired characteristics of the engine. Further, the port and combustion chamber geometry may be varied along with support ribs and cooling packages to achieve different performance. Similarly, cylinder heads may be either billet (and machined to specifications) or cast.

The above components and options are typically incorporated into a single engine design and as such are not interchangeable with different components. As such, the feasibility and affordability of making performance-related alterations to engines is limited, barring designing and constructing an entirely new engine.

### SUMMARY OF THE DISCLOSURE

In an exemplary embodiment, a modular system for internal combustion engines is provided that includes a cylinder head having a plurality of bolt holes arranged around a perimeter of the cylinder head. A camshaft carrier is selected from a plurality of camshaft carrier types, wherein each of the plurality of camshaft carrier types has different performance-related properties than each of the other camshaft carrier types, and wherein each of the plurality of camshaft carrier types includes a plurality of camshaft carrier bolt holes arranged around a camshaft carrier perimeter. The selected camshaft carrier operably attaches to the cylinder head such that the plurality of bolt holes and the plurality of camshaft carrier bolt holes are aligned.

Additionally or alternatively, at least one of the plurality of camshaft carrier types includes a camshaft carrier cover, the cover including an integral oil spray circuit.

Additionally or alternatively, the cylinder head is a billet cylinder head.

Additionally or alternatively, the cylinder head is a cast cylinder head.

Additionally or alternatively, each of the plurality of camshaft carrier types includes a scavenge circuit having an internal pathway that is different than the internal pathway of the scavenge circuit of each of the other camshaft carrier types.

Additionally or alternatively, each of the plurality of camshaft carrier types includes a valvetrain with performance characteristics that are different than the performance characteristics of the valvetrain of each of the other camshaft carrier types.

Additionally or alternatively, each of the plurality of camshaft carrier types includes a lubrication passage with performance characteristics that are different than the performance characteristics of the lubrication passage of each of the other camshaft carrier types.

Additionally or alternatively, at least one of the plurality of camshaft carrier types has direct acting buckets and at least another one of the plurality of camshaft carrier types has rockers.

Additionally or alternatively, at least one of the plurality of camshaft carrier types has a dry sump lubrication oil feed and at least another one of the plurality of camshaft carrier types has a wet sump lubrication oil feed.

In another exemplary embodiment, a modular system for internal combustion engines is provided that includes a camshaft carrier having a plurality of bolt holes arranged around a perimeter of the camshaft carrier. A cylinder head is selected from a plurality of cylinder head types, wherein each of the plurality of cylinder head types has different performance-related properties than each of the other cylinder head types, and wherein each of the plurality of cylinder head types includes a plurality of cylinder head bolt holes around a cylinder head perimeter. The camshaft carrier operably attaches to the selected cylinder head such that the plurality of bolt holes and the plurality of cylinder head bolt holes are aligned.

Additionally or alternatively, the selected cylinder head is a billet cylinder head.

Additionally or alternatively, the selected cylinder head is a cast cylinder head.

Additionally or alternatively, each of the plurality of cylinder head types includes a combustion chamber geometry that is different than the combustion chamber geometry of each of the other cylinder head types.

Additionally or alternatively, each of the plurality of cylinder head types includes a plurality of support ribs configured differently than the plurality of support ribs of each of the other plurality of cylinder head types.

In another exemplary embodiment, a modular system for generating a variety of flat engine types is provided that includes a billet cylinder head including a combustion chamber having a first geometry, a first cooling package, and a plurality of first support ribs. A first camshaft carrier includes a plurality of camshafts, a first scavenge circuit, a first valvetrain, and a first lubrication passage. A second camshaft carrier includes a plurality of second camshaft carrier camshafts, a second scavenge circuit, a second valvetrain, and a second lubrication passage, wherein the second scavenge circuit has different properties than the first scavenge circuit, the second valvetrain has different properties than the first valvetrain, and the second lubrication passage has different properties than the first lubrication passage. A cast cylinder head includes a second combustion chamber having a second geometry, a second cooling package, and a plurality of second support ribs, wherein the second geometry is different than the first geometry, the second cooling package has different properties than the first cooling package, and the plurality of second support ribs have different properties than the first support ribs. The second camshaft carrier is designed and configured to be operably attached to the billet cylinder to form a first engine head assembly, wherein the second camshaft carrier is designed and configured to be operably attached to the cast cylinder to form a second engine head assembly, wherein the first camshaft carrier is designed and configured to be operably attached to the billet cylinder to form a third engine head assembly, and wherein the first camshaft carrier is designed and configured to be operably attached to the cast cylinder to form a fourth engine head assembly.

Additionally or alternatively, the first valvetrain is a direct acting valvetrain with radiused buckets and the second valvetrain includes center pivot rockers.

Additionally or alternatively, a camshaft carrier cover is included that is designed and configured to be operably attached to the first camshaft carrier, the cover including an integral oil spray circuit.

Additionally or alternatively, the first camshaft carrier includes a plurality of bolt holes around a perimeter of the first camshaft carrier positioned such that the plurality of bolt holes are aligned with a plurality of billet cylinder head bolt holes when the first camshaft carrier is operably attached to the billet cylinder head and such that the plurality of bolt holes are aligned with a plurality of cast cylinder head bolt holes when the first camshaft carrier is operably attached to the cast cylinder head.

Additionally or alternatively, the second camshaft carrier includes a plurality of second carrier bolt holes around a second carrier perimeter of the second camshaft carrier positioned such that the plurality of second carrier bolt holes are aligned with the plurality of billet cylinder head bolt holes when the second camshaft carrier is operably attached to the billet cylinder head and such that the plurality of second carrier bolt holes are aligned with the plurality of cast cylinder head bolt holes when the second camshaft carrier is operably attached to the cast cylinder head.

In another exemplary embodiment, a modular engine system is provided that includes a camshaft carrier including a plurality of camshafts, a scavenge circuit, a valvetrain, and a lubrication passage. A billet cylinder head includes a combustion chamber having a first geometry, a first cooling package, and a plurality of first support ribs. A cast cylinder head includes a second combustion chamber having a second geometry, a second cooling package, and a plurality of second support ribs, wherein the second geometry is different than the first geometry, the second cooling package has different properties than the first cooling package, and the plurality of second support ribs have different properties than the first support ribs. The camshaft carrier is designed and configured to be removably attached to the billet cylinder head to form a first type of engine head assembly, and wherein the camshaft carrier is designed and configured to be removably attached to the cast cylinder head to form a second type of engine head assembly.

Additionally or alternatively, a camshaft carrier cover is included that is designed and configured to be operably attached to the camshaft carrier, the cover including an integral oil spray circuit.

Additionally or alternatively, a second camshaft carrier is included, the second camshaft carrier having a plurality of second camshaft carrier camshafts, a second scavenge circuit, a second valvetrain, and a second lubrication passage, wherein the second scavenge circuit has different properties than the scavenge circuit, the second valvetrain has different properties than the valvetrain, and the second lubrication passage has different properties than the lubrication passage.

Additionally or alternatively, the second camshaft carrier is designed and configured to be removably attached to the billet cylinder head to form a third type of engine head assembly, and wherein the second camshaft carrier is designed and configured to be removably attached to the cast cylinder head to form a fourth type of engine head assembly.

In another exemplary embodiment, a base for forming an engine head assembly is provided that includes a first camshaft carrier including a plurality of camshafts, a first scavenge circuit, a first valvetrain, and a first lubrication passage or a second camshaft carrier including a plurality of second camshafts, a second scavenge circuit, a second valvetrain, and a second lubrication passage, wherein the second scavenge circuit has different properties than the first scavenge circuit, the second valvetrain has different properties than the first valvetrain, and the second lubrication passage has different properties than the first lubrication passage. A cylinder head is included, wherein the cylinder head is configured to receive either the first camshaft carrier or the second camshaft carrier such that the engine head assembly is formed with either the first camshaft carrier and the cylinder head or the second camshaft carrier and the cylinder head.

Additionally or alternatively, the cylinder head has a top surface and includes a plurality of bolt holes arranged around a perimeter of the top surface.

Additionally or alternatively, a camshaft carrier cover is included that is designed and configured to be operably attached to the camshaft carrier, the cover including an integral oil spray circuit.

In another exemplary embodiment, a method for modifying properties of a flat engine includes detaching a first camshaft carrier from a first cylinder head, the first camshaft carrier including a plurality of camshafts, a first scavenge circuit, a first valvetrain, and a first lubrication passage, and attaching a second camshaft carrier to the first cylinder head, the second camshaft carrier including a plurality of second camshafts, a second scavenge circuit, a second valvetrain, and a second lubrication passage such that the combination of the first camshaft carrier and first cylinder head has different performance characteristics than the combination of the second camshaft carrier and the second cylinder head.

Additionally or alternatively, the method further includes attaching the first camshaft carrier to a second cylinder head, the second cylinder head having a combustion chamber with a geometry that is different than a geometry of a combustion chamber of the first cylinder head, a cooling package that is different than a cooling package of the first cylinder head, and a plurality of support ribs that are different than a plurality of support ribs in the first cylinder head.

Additionally or alternatively, the method further includes detaching the first camshaft carrier from the second cylinder head, detaching the second camshaft carrier from the first cylinder head, and attaching the second camshaft carrier to the second cylinder head, wherein the combination of the second camshaft carrier and second cylinder head has different performance characteristics than the combination of the first camshaft carrier and the second cylinder head.

Additionally or alternatively, the method includes attaching a cover to the first camshaft carrier, wherein the cover includes an integral oil spray circuit.

Additionally or alternatively, the step of attaching the second camshaft carrier to the second cylinder head includes aligning a plurality of bolt holes around a perimeter of the second camshaft carrier with a plurality of second cylinder head bolt holes around a perimeter of the second cylinder head.

In another exemplary embodiment, a method for preparing a horizontal internal combustion engine from modular components is provided that includes selecting a camshaft carrier selected from a plurality of camshaft carrier types, wherein each of the plurality of camshaft carrier types has different performance related properties than each of the other camshaft carrier types, wherein at least one of the plurality of camshaft carrier types has direct acting buckets and at least another one of the plurality of camshaft carrier types has rockers. The method also includes selecting a cylinder head selected from a plurality of cylinder head types, wherein each of the plurality of cylinder head types has different performance related properties than each of the other cylinder head types, wherein each of the plurality of cylinder head types is interchangeable with respect to operable attachment to each of the plurality of camshaft carrier types, and attaching the selected camshaft carrier to the selected cylinder head.

Additionally or alternatively, the step of attaching includes bolting the selected camshaft carrier to the selected cylinder head, through a plurality of bolt holes around a perimeter of the selected camshaft carrier and through a corresponding plurality of bolt holes through the selected cylinder head.

In another embodiment, a cylinder head base is provided that accepts, alternatively, a first camshaft carrier having a first scavenge circuit, a first valvetrain, a first lubrication passage, and a plurality of first camshaft carrier bolt holes around a first camshaft carrier perimeter, or a second camshaft carrier having a second scavenge circuit, a second valvetrain, a second lubrication passage, and a plurality of second camshaft carrier bolt holes around a second camshaft carrier perimeter, wherein the second scavenge circuit has different properties than the first scavenge circuit, the second valvetrain has different properties, than the first valvetrain, and the second lubrication passage has different properties than the first lubrication passage. The cylinder head base includes a combustion chamber, a cooling package, a plurality of support ribs, and a plurality of bolt holes around a perimeter of the cylinder head base configured to align with the plurality of first camshaft carrier bolt holes when the cylinder head base is operably attached to the first camshaft carrier and to align with the plurality of second camshaft carrier bolt holes when the cylinder head base is operably attached to the second camshaft carrier.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a perspective view of a modular engine in accordance with an embodiment of the present invention;

FIG. 1B an exploded view of the modular engine shown in FIG. 1A;

FIG. 1C is a bottom perspective view of the modular engine shown in FIG. 1A,

FIG. 1D is a bottom exploded view of the modular engine shown in FIG. 1A;

FIG. 2A is a perspective view of another modular engine in accordance with an embodiment of the present invention;

FIG. 2B an exploded view of the modular engine shown in FIG. 2A;

FIG. 2C is a bottom perspective view of the modular engine shown in FIG. 2A;

FIG. 2D is a bottom exploded view of the modular engine shown in FIG. 2A;

FIG. 3A is a perspective view of a modular engine in accordance with an embodiment of the present invention composed of components from the modular engine of FIG. 1A and the modular engine of FIG. 2A;

FIG. 3B an exploded view of the modular engine shown in FIG. 3A;

FIG. 3C is a bottom perspective view of the modular engine shown in FIG. 3A;

FIG. 3D is a bottom exploded view of the modular engine shown in FIG. 3A;

FIG. 4A is a perspective view of another modular engine in accordance with an embodiment of the present invention composed of components from the modular engine of FIG. 1A and the modular engine of FIG. 2A;

FIG. 4B an exploded view of the modular engine shown in FIG. 4A;

FIG. 4C is a bottom perspective view of the modular engine shown in FIG. 4A; and

FIG. 4D is a bottom exploded view of the modular engine shown in FIG. 4A.

### DESCRIPTION OF THE DISCLOSURE

A modular head design in which cylinder head bases, camshaft carriers, and camshaft covers with different attributes can be interchanged with one another allows for an engine to be assembled for achieving various desired characteristics without the need to replace the entire engine or design an entirely new engine whenever new components with different performance attributes are desired.

The benefits of a modular head design can be realized by allowing each section (e.g., cylinder head base, a camshaft carrier, and a camshaft cover) of the engine to be freely exchanged with a different style (i.e., not just a replacement) of the section without altering the other sections. For example, by switching from one camshaft carrier to another, e.g., direct acting buckets can be swapped for rockers, while the other sections (e.g., cylinder head bases and camshaft covers) of the engine remain the same. Similarly, a different cylinder head base may replace another cylinder head in order to alter water-flow or air path while the camshaft carrier and covers can stay the same. This increases design flexibility by allowing multiple variations of engines to be assembled from a few core components without the expense and labor typically associated with this level of design flexibility.

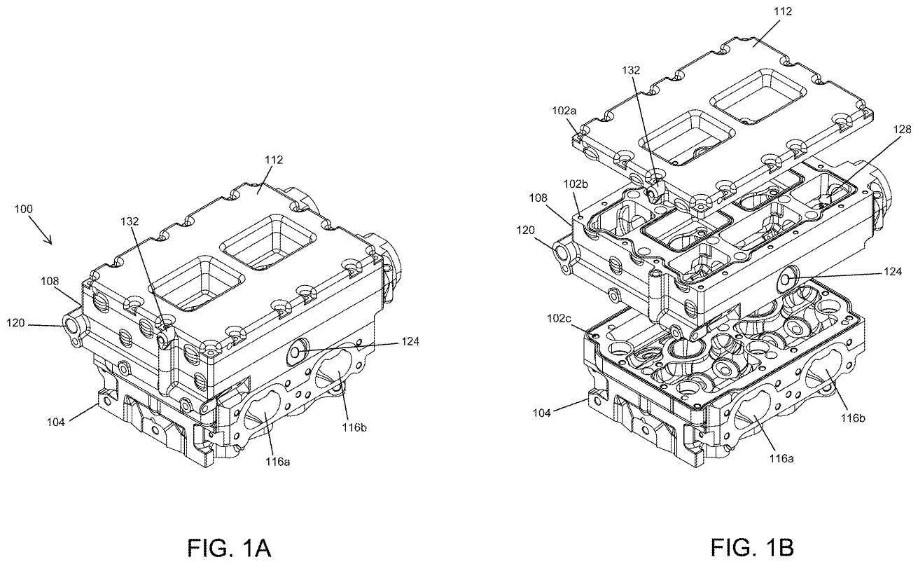

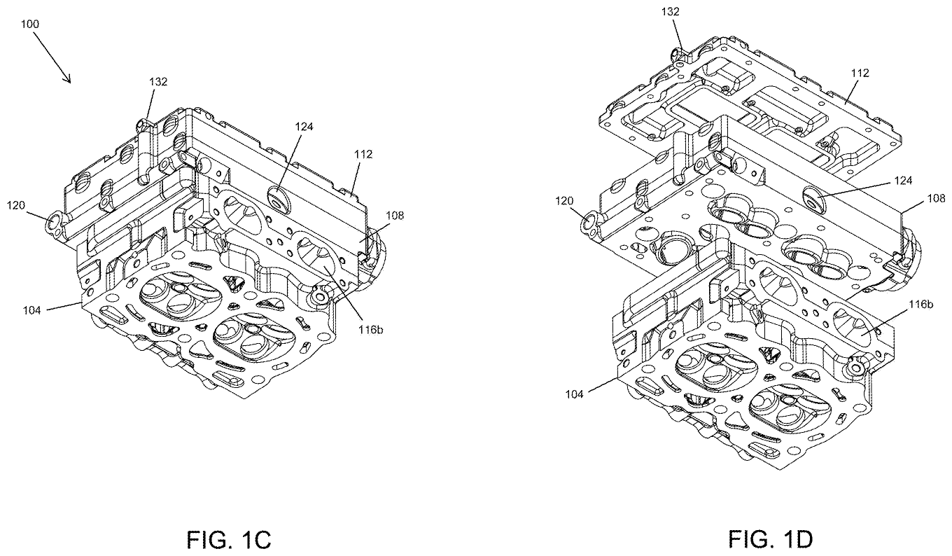

Turning to the Figures, and in particular FIGS. 1A-1D, a head assembly 100 for boxer style engines includes three modular components: a cylinder head 104, a camshaft carrier 108, and a camshaft carrier cover 112. Cylinder head 104 can include a combustion chamber 116 (e.g., 116a, 116b), inlet ports, exhaust ports, water cooling passages, sensors (e.g., a cylinder pressure sensor, a temperature sensor, and a pressure sensor), and a fuel delivery system (all not shown for clarity, but it is understood that these are known components of a cylinder head). Cylinder head 104 is a billet cylinder head that is machined to specification, and includes an internal cooling package and internal support ribs. Combustion chamber 116 has a particular geometric profile, as can be seen in FIG. 1A.

Camshaft carrier 108 bolts to cylinder head 104 and houses camshafts, buckets, and springs (each not shown, but known in the art), as well as a scavenge circuit 120, a lubrication circuit 124, and a valvetrain 128.

Camshaft carrier cover 112 secures over camshaft carrier 108 and includes an integral oil spray circuit 132. Camshaft carrier cover 112 and camshaft carrier 108 each contain about half of the dry sump passage and they are sealed with an O-ring.

Each of camshaft carrier cover 112, camshaft carrier 108, and cylinder head 104 include a plurality of bolt holes 102 (e.g., 102a, 102b, 102c in FIG. 1B) that align when camshaft carrier cover 112, camshaft carrier 108, and cylinder head 104 are operably attached.

Taken together, the above features and characteristics give head assembly 100 certain performance properties that may be desirable for certain applications.

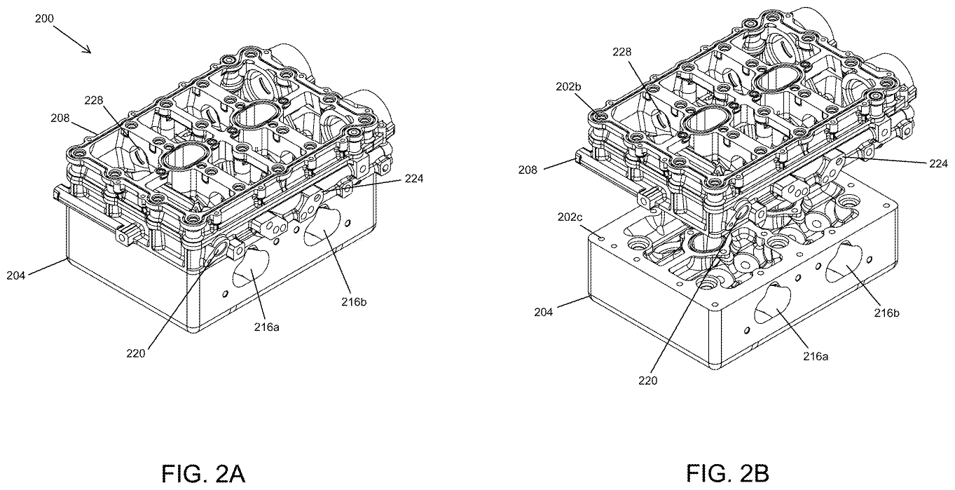

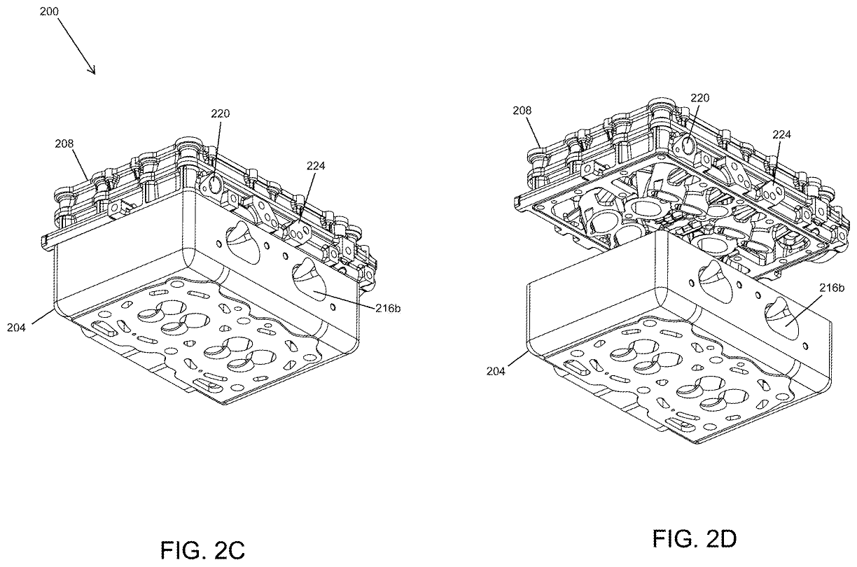

Turning now to FIGS. 2A-2D, another head assembly 200 for boxer style engines includes three modular components: a cylinder head 204, a camshaft carrier 208, and a camshaft carrier cover (not shown). Cylinder head 204 can include a combustion chamber 216 (e.g., 216a, 216b), inlet ports, exhaust ports, water cooling passages, sensors (e.g., a cylinder pressure sensor, a temperature sensor, and a pressure sensor), and a fuel delivery system (all not shown for clarity, but it is understood that these are known components of a cylinder head). Cylinder head 204 is a cast cylinder head that is produced in a mold, and includes an internal cooling package and internal support ribs. Combustion chamber 216 has a particular geometric profile, as can be seen in FIG. 2A, that differs from the geometric profile of combustion chamber 116 of head assembly 100.

Camshaft carrier 208 bolts to cylinder head 204 and houses camshafts, buckets, and springs, as well as a scavenge circuit 220, a lubrication circuit 224, and a valvetrain 228. Scavenge circuit 220, lubrication circuit 224, and valvetrain 228 have different properties than scavenge circuit 120, lubrication circuit 124, and valvetrain 128 of head assembly 100.

Camshaft carrier 208 and cylinder head 204 include a plurality of bolt holes 202 (e.g., 202b, 202c in FIG. 2B) that align when camshaft carrier 208 and cylinder head 204 are operably attached.

Taken together, the above features and characteristics give head assembly 200 certain performance properties that may be desirable for certain applications.

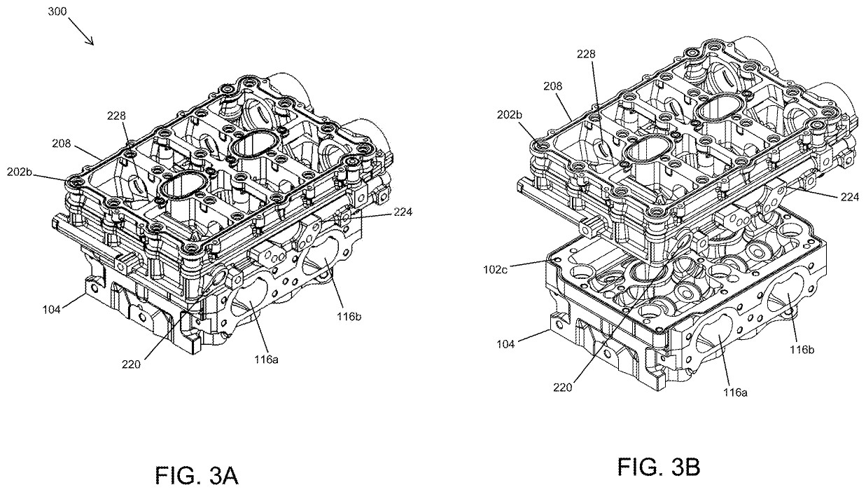

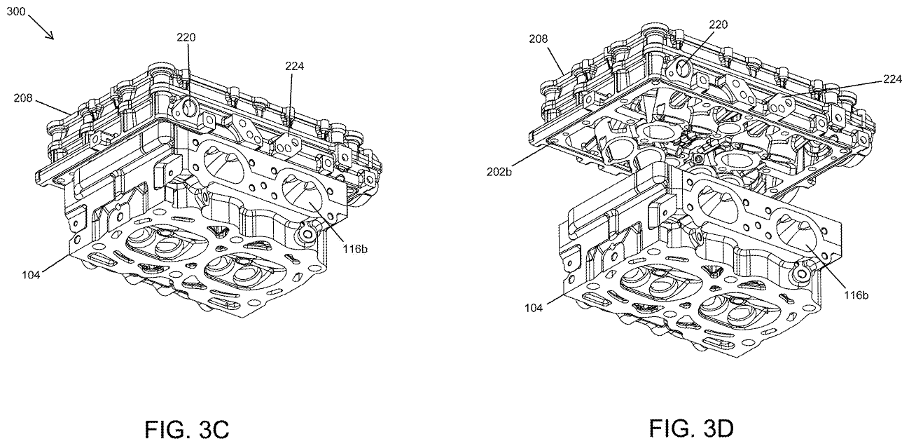

Head assembly 100 and head assembly 200 have different properties. Because the modular components of these engines are interchangeable, it is possible to prepare additional engine head assemblies with new properties without having to design and produce completely new head assemblies. For example, and turning to FIGS. 3A-3D, another engine head assembly, head assembly 300, can be formed by operably attaching camshaft carrier 208 (from head assembly 200) to cylinder head 104 (from head assembly 100). Camshaft carrier 208 is configured to be operably attached to both cylinder head 204 and cylinder head 104. The plurality of bolt holes of camshaft carrier 208 align with the plurality of bolt holes of cylinder head 104, for example hole 102c aligns with hole 202b so that the modular components may be operably connected.

Head assembly 300 includes scavenge circuit 220, lubrication circuit 224, and valvetrain 228 together with billet cylinder head 104, which includes combustions chambers 116 that have a particular geometric profile. This combination results in head assembly 300 having different performance characteristics than either head assembly 100 or head assembly 200.

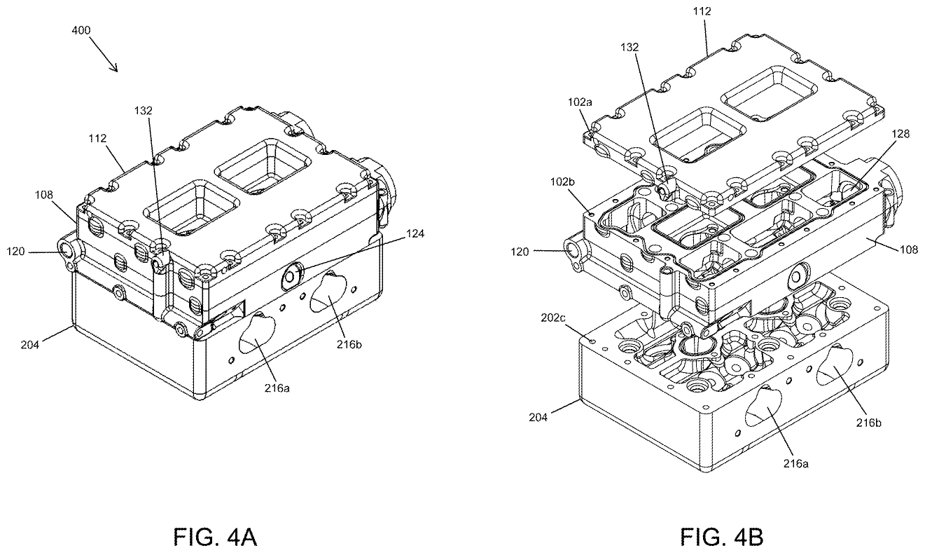

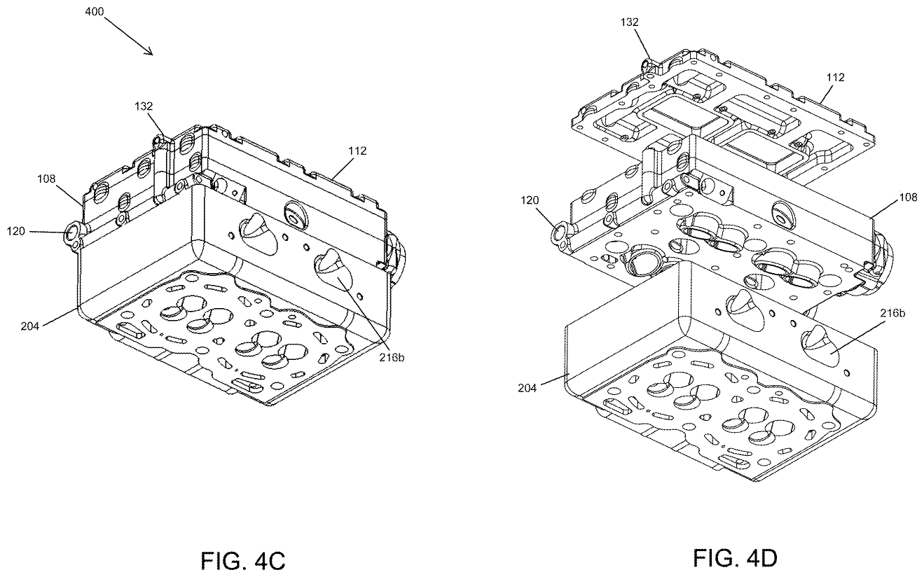

Similarly, still another engine head assembly, head assembly 400, as shown in FIGS. 4A-4D, can be formed by operably attaching camshaft carrier 108 and camshaft carrier cover 112 to cylinder head 204. Camshaft carrier 108, along with camshaft carrier cover 112, is configured to be operably attached to both cylinder head 204 and cylinder head 104. The plurality of bolt holes of camshaft carrier 108 align with the plurality of bolt holes of cylinder head 204, for example holes 102a, 102b, and 202c all align so that the modular components may be operably connected.

Head assembly 400 includes scavenge circuit 120, lubrication circuit 124, and valvetrain 128 together with cast cylinder head 204, which includes combustions chambers 216 that have a particular geometric profile. In addition, camshaft carrier cover 112 includes an integral oil spray circuit 132. This combination results in head assembly 400 having different performance characteristics than any of head assembly 100, head assembly 200, or head assembly 300.

As noted, to allow for the modularity of components described herein, any cylinder head can be fastened to any camshaft carrier with cylinder head studs. The bolt pattern for the cylinder head studs must be respected between the different cylinder head designs so as to allow the cylinder heads to be used with the modular camshaft carriers and to be attached to the same engine block. In addition, alterations of components are made such that the components can interconnect/interact with appropriate counterpart components.

In the above example, then, four different engine head assembly designs with four different kinds of features and different performance characteristics can be made from just two sets of interchangeable cylinder heads and camshaft carriers. This exchange of different camshaft carriers and valvetrains onto a base cylinder head as described above allows for a number of design variations. For example, the engine performance can be increased by adding a camshaft carrier designed for higher valve lift. The total gas exchange of a port is in part determined by the cam lift, cam duration, and cylinder head flow. By swapping an improved cam carrier onto an existing head, the new combination can greatly improve total inlet flow and peak performance. Similarly, exchanging a cast head for a billet head allows their different properties to be utilized without the need to create a whole new engine. Cast heads can include complex water jackets that are difficult or impossible to machine and can be produced in high volume with lower costs compared to billet head production. The modular design allows for testing small iterations (which may affect overall engine performance) and for running basic packages designed for lower power without producing new cylinder heads. In this way, the base heads can be upgraded to take advantage of new valvetrain or evolutions in the camshaft carrier without replacing the full cylinder head or having to downgrade to reduce cost.

It will be understood that, subject to compatibility, each feature may be selected to produce a component with different properties. For example, a camshaft carrier may be prepared based on selections for the following options: the camshaft carrier may be either cast or machined; the camshaft carrier may have either a dry sump lubrication or a wet sump lubrication oil feed; a Type 1 direct acting valvetrain with radiused buckets or a Type 3 valvetrain with center pivot rockers; various camshaft journal diameters and/or locations, and clearances to the head for camshaft lobes; and different cooling systems. Likewise, the cylinder base may be prepared based on selections for the following options: a machined billet construction or a cast construction; different inlet and exhaust port configurations; different cooling passages; different combustion chamber designs; a port injection or direct injection fuel delivery system; and the inclusion of additional development sensors, such as cylinder pressure sensors, local temperature sensors, and pressure sensors.

It will also be noted that more than two such variations in modular components are possible, which greatly increase the engine head assemblies that can be created using only a limited number of modular components.

In operation, a modular engine of the present invention is constructed by selecting a modular cylinder head from two or more possible cylinder head styles that has properties and components desirable for the type of engine to be made, based on, for example, the likely use for the engine. As an example, one might select a billet cylinder head to start with. The user is then able to select a camshaft carrier from two or more camshaft carriers that each have different properties and components to combine with the selected billet cylinder head. The selected cylinder head and the selected camshaft carrier are then fitted together to form an engine head assembly and respective bolt holes are aligned and then the two pieces are secured together.

Exemplary embodiments have been disclosed above and illustrated in the accompanying drawings. It will be understood by those skilled in the art that various changes, omissions and additions may be made to that which is specifically disclosed, herein without departing from the spirit and scope of the present invention.

1. A modular system for internal combustion engines comprising:
a cylinder head having a plurality of bolt holes arranged around a perimeter of the cylinder head; and
a camshaft carrier selected from a plurality of camshaft carrier types, wherein each of the plurality of camshaft carrier types has different performance-related properties than each of the other camshaft carrier types, and wherein each of the plurality of camshaft carrier types includes a plurality of camshaft carrier bolt holes arranged around a camshaft carrier perimeter,
wherein the selected camshaft carrier operably attaches to the cylinder head such that the plurality of bolt holes and the plurality of camshaft carrier bolt holes are aligned.

2. The modular system of claim 1, wherein at least one of the plurality of camshaft carrier types includes a camshaft carrier cover, the camshaft carrier cover including an integral oil spray circuit.

3. The modular system of claim 1, wherein the cylinder head is a billet cylinder head.

4. The modular system of claim 1, wherein the cylinder head is a cast cylinder head.

5. The modular system of claim 1, wherein each of the plurality of camshaft carrier types includes a scavenge circuit having an internal pathway that is different than the internal pathway of the scavenge circuit of each of the other camshaft carrier types.

6. The modular system of claim 1, wherein each of the plurality of camshaft carrier types includes a valvetrain with performance characteristics that are different than the performance characteristics of the valvetrain of each of the other camshaft carrier types.

7. The modular system of claim 1, wherein each of the plurality of camshaft carrier types includes a lubrication passage with performance characteristics that are different than the performance characteristics of the lubrication passage of each of the other camshaft carrier types.

8. The modular system of claim 1, wherein at least one of the plurality of camshaft carrier types has direct acting buckets and at least another one of the plurality of camshaft carrier types has rockers.

9. The modular system of claim 1, wherein at least one of the plurality of camshaft carrier types has a dry sump lubrication oil feed and at least another one of the plurality of camshaft carrier types has a wet sump lubrication oil feed.

10. A modular system for internal combustion engines comprising:
a camshaft carrier having a plurality of bolt holes arranged around a perimeter of the camshaft carrier; and
a cylinder head selected from a plurality of cylinder head types, wherein each of the plurality of cylinder head types has different performance-related properties than each of the other cylinder head types, and wherein each of the plurality of cylinder head types includes a plurality of cylinder head bolt holes around a cylinder head perimeter,
wherein the camshaft carrier operably attaches to the selected cylinder head such that the plurality of bolt holes and the plurality of cylinder head bolt holes are aligned.

11. The modular system of claim 10, wherein the selected cylinder head is a billet cylinder head.

12. The modular system of claim 10, wherein the selected cylinder head is a cast cylinder head.

13. The modular system of claim 10, wherein each of the plurality of cylinder head types includes a combustion chamber geometry that is different than the combustion chamber geometry of each of the other cylinder head types.

14. The modular system of claim 10, wherein each of the plurality of cylinder head types includes a plurality of support ribs configured differently than the plurality of support ribs of each of the other plurality of cylinder head types.

15. A modular system for generating a variety of flat engine types, the modular system comprising:
a billet cylinder head including a combustion chamber having a first geometry, a first cooling package, and a plurality of first support ribs;
a first camshaft carrier including a plurality of camshafts, a first scavenge circuit, a first valvetrain, and a first lubrication passage;
a second camshaft carrier including a plurality of second camshaft carrier camshafts, a second scavenge circuit, a second valvetrain, and a second lubrication passage, wherein the second scavenge circuit has different properties than the first scavenge circuit, the second valvetrain has different properties than the first valvetrain, and the second lubrication passage has different properties than the first lubrication passage; and
a cast cylinder head including a second combustion chamber having a second geometry, a second cooling package, and a plurality of second support ribs, wherein the second geometry is different than the first geometry, the second cooling package has different properties than the first cooling package, and the plurality of second support ribs have different properties than the first support ribs,
wherein the second camshaft carrier is designed and configured to be operably attached to the billet cylinder head to form a first engine head assembly, wherein the second camshaft carrier is designed and configured to be operably attached to the cast cylinder to form a second engine head assembly, wherein the first camshaft carrier is designed and configured to be operably attached to the billet cylinder head to form a third engine head assembly, and wherein the first camshaft carrier is designed and configured to be operably attached to the cast cylinder head to form a fourth engine head assembly.

16. The modular system of claim 15, wherein the first valvetrain is a direct acting valvetrain with radiused buckets and the second valvetrain includes center pivot rockers.

17. The modular system of claim 15, further including a camshaft carrier cover designed and configured to be operably attached to the first camshaft carrier, the camshaft carrier cover including an integral oil spray circuit.

18. The modular system of claim 15, wherein the first camshaft carrier includes a plurality of bolt holes around a perimeter of the first camshaft carrier positioned such that the plurality of bolt holes are aligned with a plurality of billet cylinder head bolt holes when the first camshaft carrier is operably attached to the billet cylinder head and such that the plurality of bolt holes are aligned with a plurality of cast cylinder head bolt holes when the first camshaft carrier is operably attached to the cast cylinder head.

19. The modular system of claim 15, wherein the second camshaft carrier includes a plurality of second carrier bolt holes around a second carrier perimeter of the second camshaft carrier positioned such that the plurality of second carrier bolt holes are aligned with the plurality of billet cylinder head bolt holes when the second camshaft carrier is operably attached to the billet cylinder head and such that the plurality of second carrier bolt holes are aligned with the plurality of cast cylinder head bolt holes when the second camshaft carrier is operably attached to the cast cylinder head.

20. A modular engine system comprising:
a camshaft carrier including a plurality of camshafts, a scavenge circuit, a valvetrain, and a lubrication passage;
a billet cylinder head including a combustion chamber having a first geometry, a first cooling package, and a plurality of first support ribs; and
a cast cylinder head including a second combustion chamber having a second geometry, a second cooling package, and a plurality of second support ribs, wherein the second geometry is different than the first geometry, the second cooling package has different properties than the first cooling package, and the plurality of second support ribs have different properties than the first support ribs,
wherein the camshaft carrier is designed and configured to be removably attached to the billet cylinder head to form a first type of engine head assembly, and wherein the camshaft carrier is designed and configured to be removably attached to the cast cylinder head to form a second type of engine head assembly.

21. The modular engine system according to claim 20, further including a camshaft carrier cover designed and configured to be operably attached to the camshaft carrier, the camshaft carrier cover including an integral oil spray circuit.

22. The modular engine system according to claim 20, further including a second camshaft carrier, the second camshaft carrier having a plurality of second camshaft carrier camshafts, a second scavenge circuit, a second valvetrain, and a second lubrication passage, wherein the second scavenge circuit has different properties than the scavenge circuit, the second valvetrain has different properties than the valvetrain, and the second lubrication passage has different properties than the lubrication passage.

23. The system according to claim 22, wherein the second camshaft carrier is designed and configured to be removably attached to the billet cylinder head to form a third type of engine head assembly, and wherein the second camshaft carrier is designed and configured to be removably attached to the cast cylinder head to form a fourth type of engine head assembly.

24. A base for forming an engine head assembly with a first camshaft carrier including a plurality of camshafts, a first scavenge circuit, a first valvetrain, and a first lubrication passage or a second camshaft carrier including a plurality of second camshafts, a second scavenge circuit, a second valvetrain, and a second lubrication passage, wherein the second scavenge circuit has different properties than the first scavenge circuit, the second valvetrain has different properties than the first valvetrain, and the second lubrication passage has different properties than the first lubrication passage, the base comprising:
a cylinder head, wherein the cylinder head is configured to receive either the first camshaft carrier or the second camshaft carrier such that the engine head assembly is formed with either the first camshaft carrier and the cylinder head or the second camshaft carrier and the cylinder head.

25. The base according to claim 24, wherein the cylinder head has a top surface and includes a plurality of bolt holes arranged around a perimeter of the top surface.

26. The base according to claim 24, further including a camshaft carrier cover designed and configured to be operably attached to the camshaft carrier, the camshaft carrier cover including an integral oil spray circuit.

27. A method for modifying properties of a flat engine comprising:
detaching a first camshaft carrier from a first cylinder head, the first camshaft carrier including a plurality of camshafts, a first scavenge circuit, a first valvetrain, and a first lubrication passage; and
attaching a second camshaft carrier to the first cylinder head, the second camshaft carrier including a plurality of second camshafts, a second scavenge circuit, a second valvetrain, and a second lubrication passage such that the combination of the first camshaft carrier and first cylinder head has different performance characteristics than the combination of the second camshaft carrier and the second cylinder head.

28. The method for modifying properties of a flat engine of claim 27, further including:
attaching the first camshaft carrier to a second cylinder head, the second cylinder head having a combustion chamber with a geometry that is different than a geometry of a combustion chamber of the first cylinder head, a cooling package that is different than a cooling package of the first cylinder head, and a plurality of support ribs that are different than a plurality of support ribs in the first cylinder head.

29. The method for modifying properties of a flat engine of claim 28, further including:
detaching the first camshaft carrier from the second cylinder head;
detaching the second camshaft carrier from the first cylinder head; and
attaching the second camshaft carrier to the second cylinder head, wherein the combination of the second camshaft carrier and second cylinder head has different performance characteristics than the combination of the first camshaft carrier and the second cylinder head.

30. The method for modifying properties of a flat engine of claim 29, further including attaching a cover to the first camshaft carrier, wherein the cover includes an integral oil spray circuit.

31. The method for modifying properties of a flat engine of claim 30, wherein the step of attaching the second camshaft carrier to the second cylinder head includes aligning a plurality of bolt holes around a perimeter of the second camshaft carrier with a plurality of second cylinder head bolt holes around a perimeter of the second cylinder head.

32. A method for preparing a horizontal internal combustion engine from modular components comprising:
selecting a camshaft carrier selected from a plurality of camshaft carrier types, wherein each of the plurality of camshaft carrier types has different performance related properties than each of the other camshaft carrier types, wherein at least one of the plurality of camshaft carrier types has direct acting buckets and at least another one of the plurality of camshaft carrier types has rockers;
selecting a cylinder head selected from a plurality of cylinder head types, wherein each of the plurality of cylinder head types has different performance related properties than each of the other cylinder head types, wherein each of the plurality of cylinder head types is interchangeable with respect to operable attachment to each of the plurality of camshaft carrier types; and
attaching the selected camshaft carrier to the selected cylinder head.

33. The method for preparing a horizontal internal combustion engine according to claim 32 wherein the step of attaching includes bolting the selected camshaft carrier to the selected cylinder head through a plurality of bolts holes around a perimeter of the selected camshaft carrier and through a corresponding plurality of bolt holes through the selected cylinder head.

34. A cylinder head base for accepting, alternatively, a first camshaft carrier having a first scavenge circuit, a first valvetrain, a first lubrication passage, and a plurality of first camshaft carrier bolt holes around a first camshaft carrier perimeter, or a second camshaft carrier having a second scavenge circuit, a second valvetrain, a second lubrication passage, and a plurality of second camshaft carrier bolt holes around a second camshaft carrier perimeter, wherein the second scavenge circuit has different properties than the first scavenge circuit, the second valvetrain has different properties than the first valvetrain, and the second lubrication passage has different properties than the first lubrication passage, the cylinder head base comprising:
a combustion chamber;
a cooling package;
a plurality of support ribs; and
a plurality of bolt holes around a perimeter of the cylinder head base configured to align with the plurality of first camshaft carrier bolt holes when the cylinder head base is operably attached to the first camshaft carrier and to align with the plurality of second camshaft carrier bolt holes when the cylinder head base is operably attached to the second camshaft carrier.
